(19) United States
(12) Patent Application Publication
(10) Pub. No.: US 2011/0185966 A1
(43) Pub. Date: Aug. 4, 2011

(54) MASK ASSEMBLY

(76) Inventors: Il Hyun LEE, Gyeonggi-do (KR); Tae Hyung Kim, Daegu (KR); Chong Hyun Park, Daegu (KR)

(21) Appl. No.: 12/980,511

(22) Filed: Dec. 29, 2010

(30) Foreign Application Priority Data
Feb. 2, 2010 (KR) 10-2010-0009565

(51) Int. Cl. B05C 11/00

(52) U.S. Cl. 118/504

(57) ABSTRACT

A mask assembly capable of improving organic material deposition efficiency is disclosed. The mask assembly comprises: a plurality of deposition masks; a frame coupled to the plurality of deposition masks arranged continuously; and a bonding portion for joining adjacent deposition masks.

### CROSS REFERENCE TO RELATED APPLICATION

This application claims the benefit of the Patent Korean Application No. 10-2010-0009565, filed on Feb. 2, 2010, which is hereby incorporated by reference as if fully set forth herein.

### BACKGROUND OF THE DISCLOSURE

1. Field of the Disclosure

The present invention relates to mask assemblies, and more particularly, to a mask assembly which can improve organic material deposition efficiency and characteristic uniformity of a finished organic light emitting display device in a process of forming an organic layer of the organic light emitting display device.

2. Discussion of the Related Art

Recently, the increasing prominence of information technology has led to advances in display technology for visually displaying electrical information signals. Accordingly, a variety of flat panel displays having superior performance including slim design, low weight and low power consumption have been developed and rapidly replaced conventional Cathode Ray Tubes (CRT).

Representative examples of flat panel displays may include a Liquid Crystal Display (LCD), Plasma Display Panel (PDP), Field Emission Display (FED), Electro Luminescent Display (ELD), Electro-Wetting Display (EWD), and Organic Light Emitting Diode (OLED) display.

Of the aforementioned displays, an organic light emitting diode (hereinafter, referred to as “OLED”) displays an image using organic light emitting diodes. An OLED is designed to generate light of a specific wavelength by exciton energy generated by recombination of electrons and holes. Such an OLED has advantages including superior display characteristics, such as high contrast ratio and fast response time, and easy realization of a flexible display, and, it may be classed as such an ideal next generation display.

In a general OLED, an active area in which a plurality of subpixels is arranged in a matrix and a remaining area, referred to as an inactive area, are defined. Each subpixel includes a thin-film transistor and an organic light emitting diode. The organic light emitting diode includes a first electrode, an organic layer, and a second electrode. The organic layer includes a hole injection layer, a hole transport layer, a light emitting layer, an electron transport layer, and an electron injection layer. The OLED having the above described configuration displays an image by applying a voltage of several volts to the first electrode and the second electrode. Thereby, current passing through the organic layer induces emission of light. That is, the OLED displays an image using the principle of emitting light using remnant energy which is generated by an exciton falling back to a ground state. The exciton is generated by recombination of hole and electron injected from the first electrode and the second electrode.

Meanwhile, in an organic layer forming process, a mask assembly is used to form light emitting regions corresponding to the subpixels. In this case, the mask assembly includes a frame coupled to the deposition mask and a deposition mask which is formed of a metal or plastic thin film and includes an aperture area corresponding to the active area and an intercepting area outside of the aperture area. In the mask assembly, the deposition mask is flat in an unfolded state thereof and is coupled to the frame via, e.g., welding. The frame is configured to maintain the flat state of the deposition mask.

To achieve improved yield by simultaneously manufacturing a plurality of organic light emitting displays, or to increase a size of an organic light emitting display, a size of a substrate is gradually increasing. This necessitates an increase in the size of the mask assembly to correspond to the substrate.

As described above, when a single deposition mask constitutes a large mask assembly, the deposition mask should have a large size. Therefore, even if the deposition mask is coupled to the frame in a stretched state, the deposition mask may sag under the weight. This sagging deposition mask may not come into close contact with the substrate, thereby making it difficult to perform deposition of organic matter according to a designed pattern. Moreover, if excessive tensile force is applied to the deposition mask to prevent the sag phenomenon, the tensile force may deform a pattern of the deposition mask, making it difficult to perform deposition of organic matter according to a designed pattern.

To solve the above described problems, constituting a large mask assembly corresponding to a large substrate using a plurality of deposition masks (hereinafter, referred to as “split deposition masks”) has been attempted.

FIG. 1 illustrates a plan view of a related art mask assembly.

Referring to FIG. 1, the related art mask assembly 10 is provided with a plurality of divisional deposition masks 11, and a rectangular frame 12 coupled to the plurality of the divisional deposition masks 11. In this instance, each of the divisional deposition masks 11 is coupled to the frame 12 in a state the divisional deposition mask 11 is spread flat by a predetermined tensile force applied to upper and lower ends thereof. Since the plurality of divisional deposition masks 11 have comparatively small sizes, the phenomenon of sagging the deposition mask 11 under the weight can be prevented.

However, in a case of the plurality of divisional deposition masks 11, an entire periphery of the deposition mask 11 is not fastened to the frame 12, but only the upper and lower ends thereof are fastened to the frame 12, causing a problem in which the plurality of divisional deposition mask 11 are coupled to the frame 12. That is, even if the divisional deposition mask 11 is coupled to the frame 12 in a state the divisional deposition mask 11 is spread flat as an adequate tensile force is applied thereto, a middle portion of the divisional deposition mask 11 becomes unfastened, or a gap between adjacent divisional deposition masks 11 becomes greater due to movement of the substrate, and impact or movement caused in a fabrication process. Since the unfastening of the divisional deposition mask 11 or the gap between adjacent divisional deposition masks 11 causes deposition different from the design, organic material deposition efficiency and uniformity of characteristics of the OLED become poor at the time of deposition of the organic material.

### SUMMARY OF THE DISCLOSURE

Accordingly, the present invention is directed to a mask assembly.

An object of the present invention is to provide a mask assembly in which joining between a plurality of deposition masks are made firm, for preventing unfastening of the plurality of the deposition masks and forming a gap between adjacent deposition masks from taking place.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a mask assembly includes a plurality of deposition masks each defined with an aperture region for passing an organic material, and a shielding region which is a periphery of the aperture region, a frame coupled to the plurality of deposition masks arranged continuously, and a bonding portion for joining adjacent deposition masks of the plurality of deposition masks.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a plan view of a related art mask assembly.

FIG. 2 illustrates a section of an exemplary apparatus for depositing an organic material in accordance with a preferred embodiment of the present invention.

FIG. 3 illustrates a plan view of a mask assembly in accordance with a first preferred embodiment of the present invention.

FIG. 4 illustrates an enlarged view of an A region in FIG. 3.

FIG. 5 illustrates a section across a line B-B in FIG. 4.

FIGS. 6A˜6C illustrate photographs of bonding portions in accordance with a first preferred embodiment of the present invention taken from above, respectively.

FIG. 7 illustrates a plan view of a case of a mask assembly in accordance with a first preferred embodiment of the present invention, having deposition masks aperture regions thereof are divided.

FIG. 8 illustrates a plan view of a mask assembly in accordance with a second preferred embodiment of the present invention.

FIG. 9 illustrates a section of a C region in FIG. 8.

FIG. 10 illustrates a plan view of a case of a mask assembly in accordance with a second preferred embodiment of the present invention, having deposition masks aperture regions thereof are divided.

FIG. 11 illustrates a plan view of a mask assembly in accordance with a third preferred embodiment of the present invention.

FIG. 12 illustrates a section of a D region in FIG. 11.

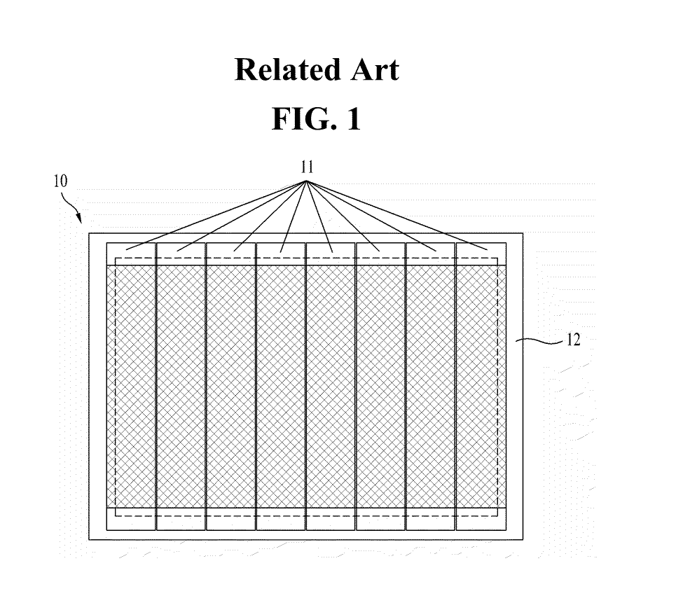

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

At first, an organic material deposition process to which a mask assembly is applied will be described.

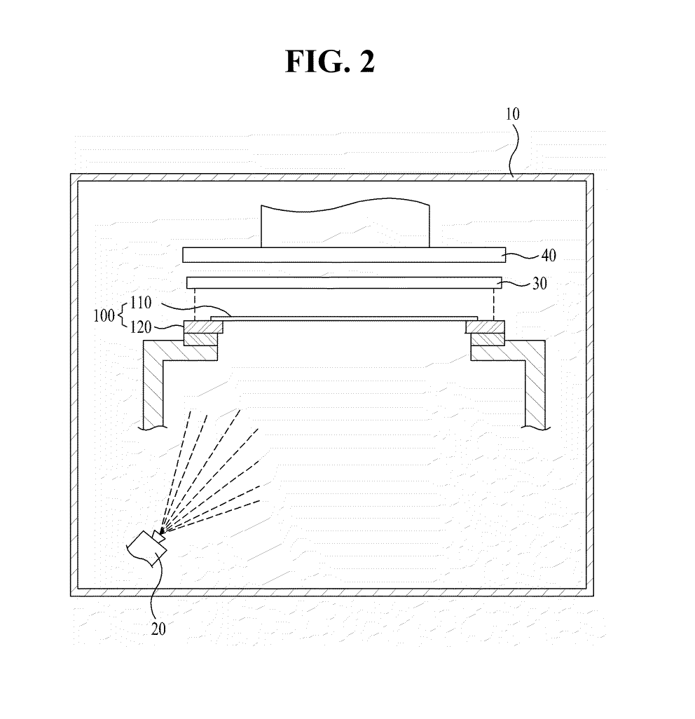

FIG. 2 illustrates a section of an exemplary apparatus for depositing an organic material in accordance with a preferred embodiment of the present invention.

Referring to FIG. 2, the apparatus for depositing an organic material includes a chamber 10 having a vacuum state maintained therein, a deposition source 20 for discharging an organic material, a mask assembly 100 arranged over the deposition source 20, a substrate 30 arranged over the mask assembly 100, and a magnet unit 40 arranged to face the mask assembly 100 with the substrate 30 disposed therebetween.

While the organic material is deposited on the substrate 30, the inside of the chamber 10 is maintained at a high vacuum and a high temperature. In this instance, though not shown, in order to maintain the high vacuum, a vacuum pump like TMP (Turbo Molecular Pump) can be arranged in the chamber 10. And, though not shown, the organic material deposition apparatus can include a thickness monitoring sensor for measuring a deposition thickness of the organic material, a thickness controller for controlling operation of the deposition source 20 according to the thickness of the organic material measured thus, and a shutter for shielding the organic material emitted from the deposition source, additionally.

The deposition source 20 is a crucible arranged at a lower side of the chamber 10 for heating the organic material to make the organic material to evaporate and discharge.

The mask assembly 100 includes deposition masks 110 for making selective passing of a deposition material, and a polygonal frame 120 coupled to the deposition masks 110. The mask assembly 100 in accordance with a preferred embodiment of the present invention will be described in more detail.

The substrate 30 includes an active region in which a plurality of cells is arranged in a matrix and depositing the organic material thereon, and a dummy region which is a periphery of the active region. In this instance, the deposition mask of the mask assembly 100 has aperture regions matched to the active region of the substrate 30. And, though not shown, the organic material deposition apparatus can further include an aligner inside the chamber 10 for aligning the substrate 30 with the mask assembly 100.

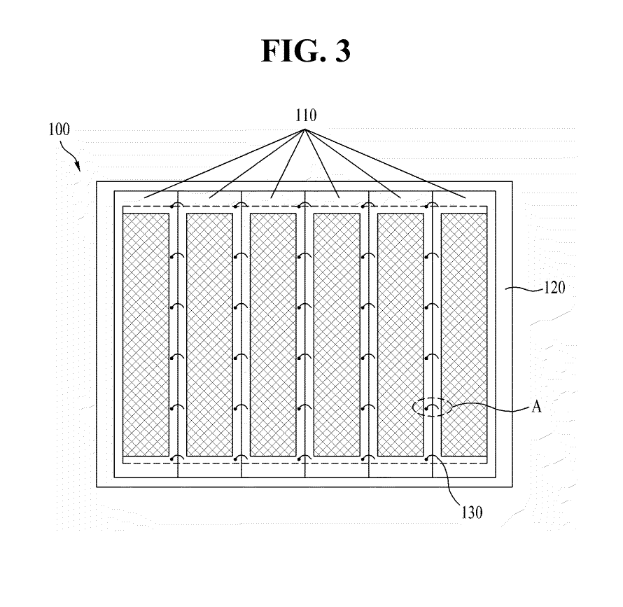

The mask assembly 100 in accordance with a first preferred embodiment of the present invention will be described with reference to FIGS. 3 to 7.

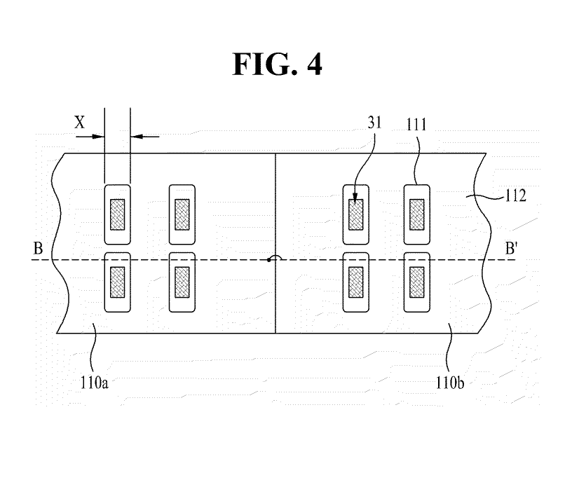

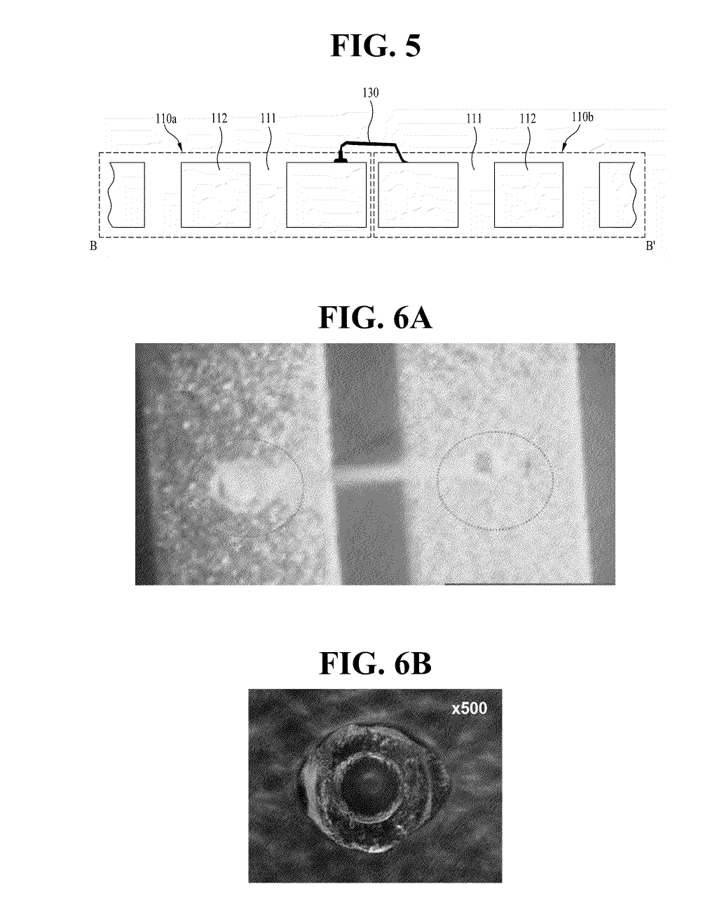

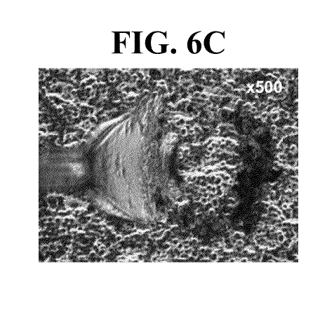

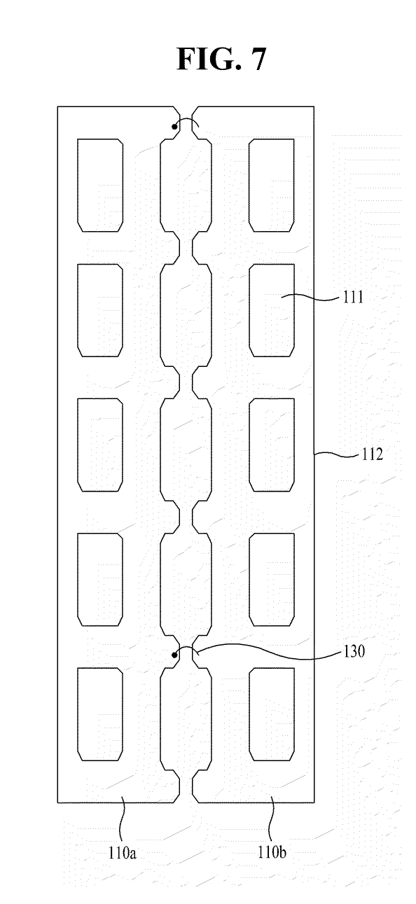

FIG. 3 illustrates a plan view of a mask assembly in accordance with a first preferred embodiment of the present invention, FIG. 4 illustrates an enlarged view of an A region in FIG. 3, and FIG. 5 illustrates a section across a line B-B in FIG. 4. FIGS. 6A˜6C illustrate photographs of bonded portions in accordance with a first preferred embodiment of the present invention taken from above, respectively. FIG. 7 illustrates a plan view of a case of a mask assembly in accordance with a first preferred embodiment of the present invention, having deposition masks aperture regions thereof are divided.

Referring to FIG. 3, the mask assembly 100 includes a plurality of deposition masks 110 each defined with an aperture region for passing an organic material, and a shielding region on a periphery of the aperture region, a frame 120 coupled to the plurality of deposition masks 110 arranged continuously, and a bonding portion 130 of ball wire for joining adjacent deposition masks. The ball wire 130 which is the bonding portion of the first embodiment joins faced sides of the adjacent deposition masks 110 by bringing a ball shape of lumped metal into contact with one of the adjacent deposition masks 110, lifting up and extending the lumped metal to the other of the adjacent deposition masks 110, and bringing the extended metal into contact with the other.

The plurality of deposition masks 110 continuously arranged are coupled to the frame 120 in a state the deposition masks 110 are stretched to spread flat as a predetermined tensile force is applied thereto. In this instance, as upper and lower ends of the plurality of deposition masks 110 are fixed to the frame 120 by welding or the like, the plurality of deposition masks 110 are coupled to the frame 120.

The frame 120 is polygonal (FIG. 3 shows a rectangular frame), and bonded to the plurality of deposition masks 110 for fixing the plurality of deposition masks 110 to maintain a spread flat state.

Referring to FIG. 4, each of the plurality of deposition masks 110 are defined with the aperture region 111 and the shielding region 112, and the aperture region 111 is formed to match with one of a plurality of cells 31 arranged in the active area of the substrate. That is, the aperture region 111 enables to form the light emitting region of the organic layer matched to one of the plurality of cells 31. The aperture region 111 can have a width X which can be greater than a width of the cell 31. Though not shown, taking a lifetime or color light generation intensity of the organic material into account, the aperture region 111 matched to a blue color cell 31 can be designed greater than the aperture region 111 matched to a red or green color cell 31.

Referring to FIG. 5, the bonding portion formed of the ball wire 130 of the first embodiment joins a first deposition mask 110a which is one of the plurality of deposition masks 110, and a second deposition mask 110b adjacent to the first deposition mask 110a. That is, the ball wire 130 is applied by a method in which, after a ball shape of lumped metal is brought into contact with a side of the first deposition mask 110a, the lumped metal is extended to the second deposition mask 110b to cross a boundary of adjacent deposition masks 110a and 110b in the shape of wire until the extended metal is brought into contact with a side of the second deposition mask 110b facing to the side of the first deposition mask 110a, when application of the wire ends. As shown in FIG. 3, one or more than one of the ball wire 130 is formed at the boundary between adjacent deposition masks 110, for joining adjacent deposition masks 110.

The ball wire 130 is formed of a metal which has an excellent ductility to extend easily, and to prevent generation of impurity gas. That is, the ball wire 130 is formed of one metal selected from gold Au, silver Ag, platinum Pt and aluminum Al, or an alloy of two or more than two above metals. A portion of a surface of the deposition mask 110 in contact with the ball wire 130 is plated with a metal of the ball wire 130 for making bonding between the deposition mask 110 and the ball wire 130 strong. For an example, the ball wire 130 can be formed of gold Au which is to be in contact with the deposition mask 110 plated with gold Au.

FIG. 6A illustrates a photograph taken from above showing a gold Au plated surface and a gold Au ball wire. In this instance, a ball shaped lump portion (on a left side in FIG. 6A) shows that a ball shape lump of gold Au shown in FIG. 6B is extended in a shape of a wire. And, an end portion of the ball wire 130 (on a right side in FIG. 6A) shows that the wire of gold is pressed down on a gold plated surface to end bonding as shown in FIG. 6C.

In the meantime, as shown in FIG. 4, the deposition mask 110 can be divided at the shielding region 112 such that the deposition mask 110 can be formed to include complete forms of the aperture regions 111 only. However, as shown in FIG. 7, the deposition mask 110 can be divided at the aperture regions 111 such that the deposition mask 110 can be formed to include incomplete forms of the aperture regions. If the deposition mask 110 has a form in which the deposition mask 110 is divided at the aperture regions 111, two deposition masks 110a and 110b are arranged side by side to form a column of complete forms of the aperture regions 111. And, a boundary of the shielding regions of the two deposition masks 110a and 110b are bonded with at least one ball wire 130.

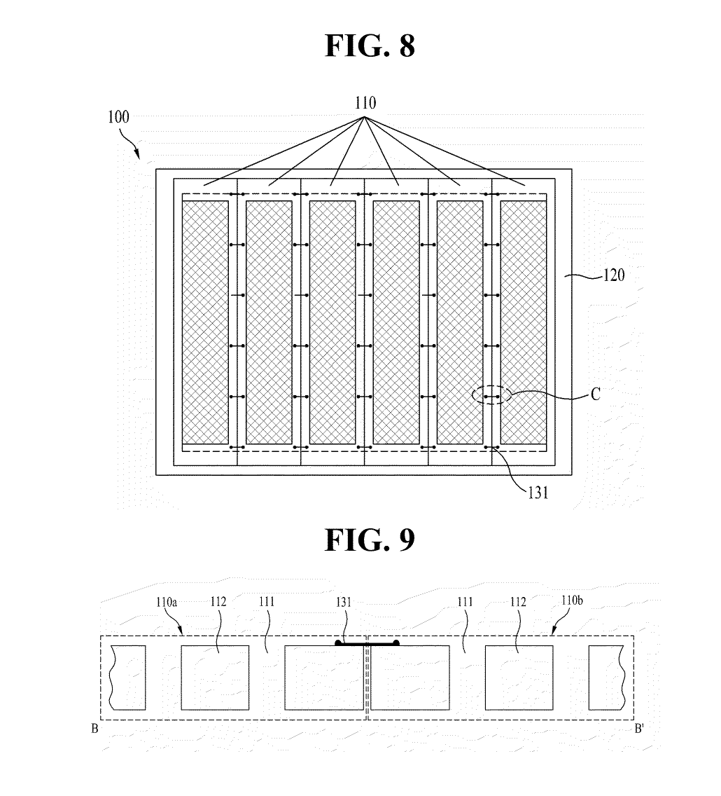

Next, a mask assembly 100 in accordance with a second preferred embodiment of the present invention will be described with reference to FIGS. 8 to 10 in detail.

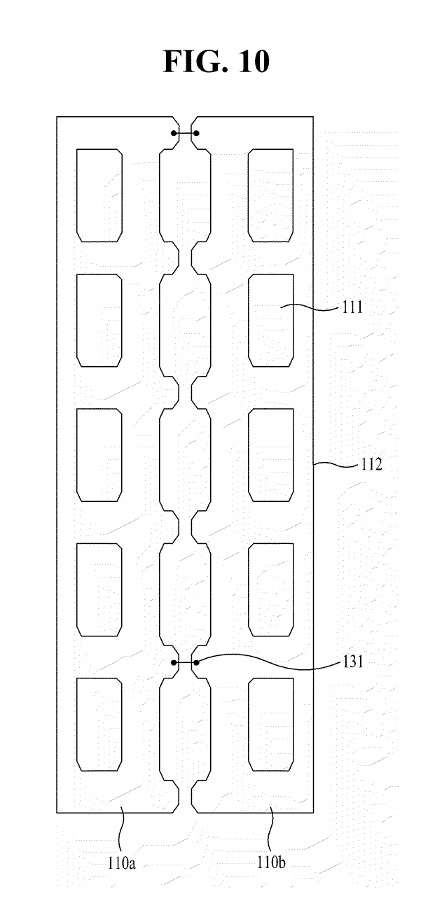

FIG. 8 illustrates a plan view of a mask assembly in accordance with a second preferred embodiment of the present invention, FIG. 9 illustrates a section of a C region in FIG. 8, and FIG. 10 illustrates a plan view of a case of a mask assembly in accordance with a second preferred embodiment of the present invention, having deposition masks aperture regions thereof are divided.

Referring to FIG. 8, the mask assembly 100 includes a plurality of deposition masks 110 each defined with an aperture region for passing an organic material, and a shielding region on a periphery of the aperture region, a frame 120 coupled to the plurality of deposition masks 110 arranged continuously, and a bonding portion 131 of a wedge wire for joining adjacent deposition masks 110. The wedge wire 131 which is the bonding portion of the second embodiment joins faced sides of the adjacent deposition masks 110 by bringing a metal into contact with one of the adjacent deposition masks 110, extending the metal to the other of the adjacent deposition masks 110 in the shape of a straight line keeping the contact with the adjacent deposition masks 110 until reaching the extended metal to the other, and bringing the extended metal into contact with the other.

Since the mask assembly in accordance with the second preferred embodiment of the present invention is identical to the mask assembly in accordance with the first preferred embodiment of the present invention except the bonding portion 131, description of duplicated portion will be omitted.

Referring to FIG. 9, the bonding portion formed of the wedge wire 131 of the second embodiment joins a first deposition mask 110a which is one of the plurality of deposition masks 110, and a second deposition mask 110b adjacent to the first deposition mask 110a. That is, the wedge wire 131 is applied by a method in which, a metal is brought into contact with a side of the first deposition mask 110a, the metal keeping the contact is extended to the second deposition mask 110b to cross a boundary of adjacent deposition masks 110a and 110b in a shape wire, the extended metal is brought into contact with a side of the second deposition mask 110b facing the side of the first deposition mask 110a. As shown in FIG. 8, one or more than one of the wedge wire 131 is formed at the boundary between adjacent deposition masks 110, for joining adjacent deposition masks 110.

The wedge wire 131 is formed of a metal which has an excellent ductility to extend easily, and to prevent generation of impurity gas. That is, the wedge wire 131 is formed of one selected from gold Au, silver Ag, platinum Pt and aluminum Al, or an alloy of two or more than two above metals. A portion of a surface of the deposition mask 110 in contact with the wedge wire 131 is plated with a metal of the wedge wire 131 for making bonding between the deposition mask 110 and the wedge wire 131 strong. For an example, the wedge wire 131 can be formed of gold Au which is to be in contact with the deposition mask 110 plated with gold Au.

In the meantime, comparing to the ball wire 130 and the wedge wire 131, the ball wire 130 is contacted with adjacent two of the deposition mask 110 in shape of bonding point, and wire portion of the ball wire 130 is formed by extending the lumped metal in state of not contact with the deposition mask 110. While the wedge wire 131 is contacted with adjacent two of the deposition mask 110 by extending the metal in state of keeping the contact with the adjacent two of the deposition mask 110.

And, alike the first embodiment, the deposition mask 110 of the second embodiment can also be formed such that the deposition mask 110 is divided at the shielding region 112 or divided at the aperture region 111. That is, as shown in FIG. 9, the deposition mask 110 can be divided at the shielding region 112 such that the deposition mask 110 can be formed to include complete forms of the aperture regions 111 only. Or, as shown in FIG. 10, the deposition mask 110 can be divided at the aperture regions 111 such that the deposition mask 110 can be formed to include incomplete forms of the aperture regions 111. If the deposition mask 110 has a form in which the deposition mask 110 is divided at the aperture regions 111 thus, two deposition masks 110a and 110b are arranged side by side to form a column of complete forms of the aperture regions 111. And, a boundary of the shielding regions of the two deposition masks 110a and 110b are joined with at least one wedge wire 131.

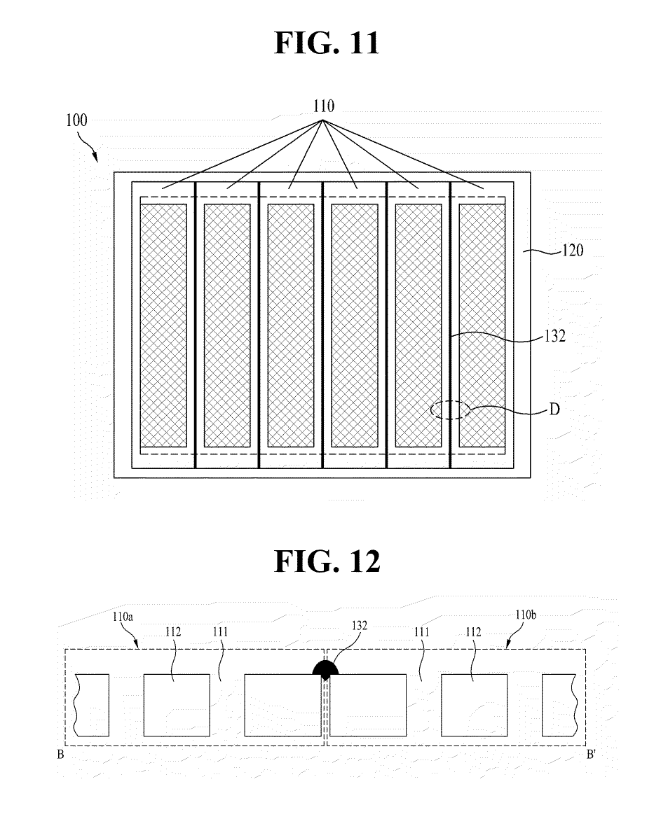

Next, a mask assembly 100 in accordance with a third preferred embodiment of the present invention will be described with reference to FIGS. 11 and 12, in detail.

FIG. 11 illustrates a plan view of a mask assembly in accordance with a third preferred embodiment of the present invention, and FIG. 12 illustrates a section of a D region in FIG. 11.

Referring to FIG. 11, the mask assembly 100 includes a plurality of deposition masks 110 each defined with an aperture region for passing an organic material, and a shielding region on a periphery of the aperture region, a frame 120 coupled to the plurality of deposition masks 110 arranged continuously, and a bonding portion 132 of bump wire for joining adjacent deposition masks 110. The bump wire 132 which is the bonding portion of the third embodiment joins faced sides of the adjacent deposition masks 110 by making a metal to be brought into contact with both of the faced sides of a boundary of the adjacent deposition masks 110. The bump wire 132 can be formed to contact with at least a portion of the boundary of the two adjacent deposition masks 110, and a plurality of the bump wire 132 each of which is in contact with a portion of the boundary can also be formed.

In the meantime, since the mask assembly in accordance with the third preferred embodiment of the present invention is identical to the mask assembly in accordance with the first or second preferred embodiment of the present invention except the bonding portion 132 of the bump wire 132 instead of the ball wire 130 or the wedge wire 131, description of duplicated portions will be omitted.

Referring to FIG. 12, the bonding portion formed of the bump wire 132 of the third embodiment joins a first deposition mask 110a which is one of the plurality of deposition masks 110, and a second deposition mask 110b adjacent to the first deposition mask 110a. In this instance, the bump wire 132 is formed at a boundary between the first deposition mask 110a and the second deposition mask 110b to be in contact with at least a portion of both of the first deposition mask 110a and the second deposition mask 110b, for joining adjacent deposition masks 110a and 110b.

In this instance, the bump wire 132 is formed of a metal which has an excellent ductility so that the bump wire 132 can be elongated easily, and to prevent emission of impurity gas. That is, the bump wire 132 is formed of one selected from gold Au, silver Ag, platinum Pt and aluminum Al, or an alloy of two or more than two above metals. A portion of a surface of the deposition mask 110 in contact with the bump wire 132 is plated with a metal of the bump wire 132 for making bonding between the deposition mask 110 and the bump wire 132 strong. For an example, the bump wire 132 can be formed of gold Au which is to be in contact with the deposition mask 110 plated with gold Au.

Thus, the mask assembly 100 in accordance with any one of the first to third preferred embodiments of the present invention includes a plurality of deposition masks 110 and a bonding portion 130, 131, or 132 for joining adjacent deposition masks 110. Accordingly, since the deposition mask 110 can be divided into small sized deposition masks, the sagging by gravity can be prevented, and, since adjacent deposition masks 110 are joined together, the unfastening of the deposition mask 110 or formation of a gap between adjacent deposition masks 110 can be prevented. Eventually, a position change of the deposition mask 110 is prevented permitting to deposit the organic material as per design in an organic layer forming process, organic material deposition efficiency can be improved, and the characteristic uniformity of the OLED can be improved.

As has been described, by making the mask assembly of the present invention to include a plurality of deposition masks, to have comparatively small sized and comparatively light deposition masks, the mask assembly of the present invention can prevent the deposition mask from sagging. And, since the mask assembly includes a bonding portion which joins adjacent deposition masks, joining between the adjacent deposition masks can become strong. Eventually, since the unfastening of the deposition mask or formation of a gap between adjacent deposition masks can be prevented, permitting to deposit the organic material as per a design, organic material deposition efficiency and characteristic uniformity of the OLED fabricated thus can be improved.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mask assembly comprising:
a plurality of deposition masks;
a frame coupled to the plurality of deposition masks arranged continuously; and
a bonding portion for joining adjacent deposition masks of the plurality of deposition masks.

2. The mask assembly according to claim 1, wherein the bonding portion is in a form of ball wire.

3. The mask assembly according to claim 1, wherein the bonding portion is in a form of wedge wire.

4. The mask assembly according to claim 1, wherein the bonding portion is in a form of bump wire.

5. The mask assembly according to claim 1, wherein the bonding portion is formed of one metal selected from gold Au, silver Ag, platinum Pt and aluminum Al, or an alloy thereof.

6. The mask assembly according to claim 1, wherein a portion of a surface of the deposition mask in contact with the bonding portion is plated with the same metal of the bonding portion.

7. The mask assembly according to claim 1, wherein each of the plurality of deposition masks includes an aperture area matched with one of a plurality of cells arranged in the active region of a substrate and a shielding region.

8. The deposition mask according to claim 7, wherein the aperture area has a width greater than that of the matched cell.

9. The mask assembly according to claim 7, wherein an aperture area matched with a blue cell has a size greater than an aperture area matched to a green or red cell.

10. The mask assembly according to claim 7, wherein the plurality of deposition masks are divided at the shielding region.

11. The mask assembly according to claim 7, wherein the plurality of deposition masks are divided at the aperture region, and a boundary of the shielding regions of the adjacent deposition masks are joined with the bonding portion
